(19) United States
(12) Patent Application Publication
(10) Pub. No.: US 2024/0313864 A1
(43) Pub. Date: Sep. 19, 2024

(54) Polarization-modification-based optical communication system

(71) Applicant: MARBEUF CONSEIL ET RECHERCHE, PARIS (FR)

(72) Inventor: Bruno SANGLE-FERRIERE, PARIS (FR)

(21) Appl. No.: 18/421,261

(22) Filed: Jan. 24, 2024

(30) Foreign Application Priority Data
Jan. 25, 2023 (FR) 2300705

(51) Int. Cl. H04B 10/532; G02B 5/30; G02B 27/28

(52) U.S. Cl. CPC H04B 10/532; G02B 5/3083; G02B 27/285

(57) ABSTRACT

An optical communication system includes a polarized-light emitter having a source (1) configured to generate at least one photon polarized with a determined polarization on a propagation path; and a complex polarization modifier (2) placed on the propagation path of the light generated by the emitter, configured to modify the polarization direction of the light and introduce a phase shift between two perpendicular components of the electric field of the light. A receiver (3) is arranged on the propagation path of the light, downstream of the complex polarization modifier (2), having a measuring instrument (35) for measuring the ellipticity and the orientation of the polarization of the light using the Jones formalism.

### RELATED APPLICATIONS

This application claims the benefit of priority from French Patent Application No. 23 00705, filed on Jan. 25, 2023, the entirety of which is incorporated by reference.

This application is also related to U.S. Pat. No. 11,843,419 issued on Dec. 12, 2023; pending U.S. patent application Ser. No. 18/514,380; and pending U.S. patent application Ser. No. 18/290,885.

### FIELD OF THE INVENTION

The present invention relates to methods for optical communication, and more particularly to those using polarization of light.

### PRIOR ART

At present, the transmission of information through optical fibers takes place mainly using electromagnetic wave trains, or by sending photons that are transmitted through an optical fiber.

Multiplexing is a technique allowing multiple information streams to be circulated by one and the same light beam or one and the same optical fiber. This may be achieved by channeling waves of different wavelengths, but also by polarization division, for example by channeling one item of information with a wave linearly polarized in a first electric field polarization direction and another item of information with a wave linearly polarized in the direction perpendicular to said first polarization direction, or else one item of information with a wave circularly polarized in one direction and another item of information with a wave circularly polarized in the other direction.

The amount of information able to circulate using multiplexing remains limited.

There is therefore a need to improve the transmission of large amounts of information.

### OBJECTS AND SUMMARY

The invention aims to address all or part of this need and relates, according to a first of its aspects, to an optical communication system comprising:
A polarized-light emitter comprising a source configured to generate at least one photon polarized with a predetermined polarization on a propagation path;
A complex polarization modifier placed on the propagation path of the light generated by the emitter, configured to modify the polarization direction of said light and introduce a phase shift between two perpendicular components of the electric field of the light;
A receiver arranged on the propagation path of the light, downstream of the complex polarization modifier, comprising a measuring instrument for measuring the ellipticity and the orientation of the polarization of the light using the Jones formalism.

The system according to the invention makes it possible to transmit information that is either discrete or in the form of continuous values between the polarization modifier and the receiver.

The photons emitted by the emitter are preferably non-entangled.

The optical communication system preferably comprises a single receiver.

The polarization state of the photon is not necessarily binary, like that of a spin. The polarization state may in particular be represented on the Jones sphere, which characterizes the orientation and ellipticity of the polarization: indeed, a polarization may be linear, the electric field always being parallel to an axis perpendicular to the direction of propagation of the photon, or circular, the electric field rotating about this axis, or between the two: the electric field running through an ellipse about the propagation axis during a period of the wave.

Multiple items of information may be communicated by the communication system, each item of information being transmitted by a luminous flux polarized with a specific polarization of the Jones formalism.

The luminous flux may be long, for example lasting one millisecond or one microsecond, and may have a high power, for example several watts. As an alternative, the luminous flux is a photon or a succession of photons, for example 1000 photons that, if they are each separated by around 10 periods, that is to say 10 times the wavelength, form a luminous flux with a power of around 0.1 mW lasting around 30 ps.

A polarization modifier is understood to mean a component that makes it possible to modify the polarization direction by a predetermined angle, on the one hand, and to introduce a phase shift between two perpendicular components of the electric field of each photon, for example along the eigenaxes of the polarization modifier, on the other hand.

### Emitter

The emitter may be configured to emit light with a predetermined polarization, in particular with a linear polarization along a predetermined axis.

The emitter may comprise a source configured to emit light with a random polarization and, downstream of this source, a linear polarizer configured to select a polarization direction of the photon.

The linear polarizer may comprise a birefringent optically transparent material, for example lithium niobate or rutile.

The emitter may comprise a single-photon source configured to emit photons one by one and separated in time by a duration of the order of a few periods of the light, for example 10 or 100.

The emitter may be configured to successively generate a plurality of photons.

The emitter may comprise a clock.

### Polarization Modifier

The polarization modifier is advantageously designed such that its user is able to choose the polarization state in which the photon is sent to the receiver from among any one of the possible polarizations as defined by the Jones formalism, in particular from among a set of elliptical polarizations (also known as “ellipsoidal” polarizations).

In one embodiment, the linear polarization of a luminous flux may be transformed into an ellipsoidal polarization as represented by the Jones formalism by first of all modifying the polarization orientation of a luminous flux with a linear polarization and known direction, thus distributing the electric field along an axis x and an axis y perpendicular to the axis x in a predetermined manner, and then, second of all, by modifying the phase of the electric field along one of two perpendicular directions, for example the axis y.

The polarization modifier may comprise a polarization ellipticity modifier on the propagation path between the emitter and the receiver.

The polarization modifier preferably comprises a polarization direction modifier arranged on the propagation path between the emitter and the polarization ellipticity modifier or between the polarization ellipticity modifier and the receiver.

For example, if a linearly polarized light has its polarization rotated by an angle θ with respect to the axis x and if ϕ is the phase shift between the electric field along the axis x and the electric field along the axis y, ω being the angular frequency of the electric field, the electric field components Eₓ and E_{y} are:

Eₓ=E Cos(θ)Cos(ωt)

E_{y}=E Sin(θ)Cos(ωt+ϕ)

### Polarization Direction Modifier:

The polarization direction modifier may comprise a half-wave plate, in particular a variable-orientation half-wave plate.

As a variant, the polarization direction modifier may comprise a first quarter-wave plate configured to modify the linear polarization of the luminous flux incident on the polarization direction modifier to circular polarization, preferably followed by a second quarter-wave plate transforming the circular polarization into linear polarization of the luminous flux oriented along an axis depending on the direction of the axis of the second quarter-wave plate.

The orientation of at least one of the two quarter-wave plates may be variable.

Rotating the axis of the second quarter-wave plate makes it possible to modify the direction of the linear polarization of the luminous flux. If the plate is a half-wave plate, rotating the half-wave plate makes it possible to modify the direction of the linear polarization of the luminous flux.

As an alternative, the orientation of the first quarter-wave plate may be modified, that of the second quarter-wave plate being fixed, or the orientations of the two quarter-wave plates may be modified.

A quarter-wave plate or a half-wave plate is rotated for example by mechanical servo-control to a sensor or to an electrically controlled device allowing the rotation thereof, for example by rubbing on an axle set in motion by a piezoelectric material or by an electric motor device, for example a DC electric motor device.

Since the rotational inertia of a quarter-wave plate may be high, the luminous fluxes may be sent successively to various quarter-wave plates the orientations of which have been adjusted beforehand, for example by a mechanical rotation device, thereby making it possible to leave time to modify the direction of each of the quarter-wave plates between two passages of luminous flux.

As a variant, the polarization direction modifier may comprise twisted liquid crystals, or twisted nematics, and the polarization direction may be modified by passing the luminous flux through the liquid crystals above and below which there are located transparent electrodes that control the rotary power of said liquid crystals.

As a variant, the polarization direction modifier may comprise chiral or rotary materials. The polarization direction modifier may comprise a plate or a prism made of chiral or rotary material that affects the rotation of the polarization by an angle that depends on the location where the luminous flux enters said chiral or rotary material. The material may in particular be arranged between materials whose refractive index or indices are dynamically adjustable.

As an alternative, the polarization modifier may comprise multiple polarization direction modifiers, each allowing different polarization rotation angles. Said multiple polarization direction modifiers are fixed, for example. As a variant, the orientation of at least one, in particular all, of said polarization direction modifiers may be modifiable.

The luminous flux may be sent to various polarization direction modifiers that rotate the polarization by predefined angles and then return the luminous flux at the output of these polarization direction modifiers as a single flux.

The polarization modifier may comprise one or more first plates or one or more first prisms whose refractive index or indices are dynamically adjustable. The luminous flux may be sent, at a first point, onto the first plate or plates or the first prism or prisms, and the luminous flux may exit the first plate or plates or the first prism or prisms at a second point with an ordinate and/or abscissa different from the first point.

The polarization modifier may comprise, downstream of the first plate or plates or of the first prism or prisms, an intermediate device, in particular comprising an at least partially chiral or rotary material. The luminous flux exits in particular the first plate or plates or the first prism or prisms by entering an intermediate device, causing the polarization direction of the luminous flux to rotate by an angle that depends on the point via which the luminous flux enters said intermediate device. The intermediate device may comprise a plate or a prism.

The polarization modifier may comprise, downstream of the intermediate device, one or more second plates or one or more second prisms, and possibly one or more third plates or one or more third prisms, whose refractive index or indices are dynamically adjustable and for which the refractive index or indices are in particular adjusted symmetrically with respect to those of the first plate or plates or of the first prism or prisms. The luminous flux exiting the intermediate device may enter the second plate or plates or the second prism or prisms, and possibly the third plate or plates or the second prism or prisms.

The luminous flux may exit the second plate or plates or the second prism or prisms in the same direction as if the refractive index of the first plate or plates or of the first prism or prisms and of the second plate or plates or of the second prism or prisms both had a fixed and non-dynamic value.

The intermediate device is for example composed of two joined-together symmetrical prisms, having the same refractive index, but having different chiral or rotary powers, the first of the two prisms having for example a chiral or rotary power and the second not having one, or rotating the polarization in the opposite direction to the rotation imposed by the first prism.

One of the two prisms may comprise a chiral material, for example cadmium selenide (CdSe) nanoparticles with a diameter in particular between 1.4 nm and 2.4 nm, as described in the article by Visheratina, Anastasia, and Nicholas A. Kotov. “Inorganic nanostructures with strong chiroptical activity.” (CCS Chemistry 2.3 (2020): 583-604.).

The other of the two prisms is preferably non-chiral or, alternatively, has a chirality opposite that of said first prism. Since the rotation of the polarization direction of the luminous flux passing through a chiral material is proportional to the thickness through which said chiral material passes, the rotation of the polarization direction of the luminous flux passing through the intermediate device depends on the entry point of the luminous flux into the intermediate device.

As an alternative, the intermediate device may comprise a “rotary” material, such as a quarter-wave plate followed by a juxtaposition of quarter-wave plates arranged such that a wave polarized linearly along the axis of the first portion of the material exits the second portion of the material with a polarization rotated by a predetermined angle.

As an alternative, the intermediate device may comprise a “rotary” material, such as a juxtaposition of half-wave plates arranged such that a wave polarized linearly along the axis of the first portion of the material exits the second portion of the material with a polarization rotated by a predetermined angle.

As an alternative, the intermediate device may comprise a “rotary” material, such as a juxtaposition of cylinders comprising chiral materials with different concentrations.

The plates or prisms whose refractive index or indices are dynamically adjustable comprise for example liquid crystals or one or two Pockels cells arranged between two transparent electrodes.

Since Pockels cells are birefringent materials whose birefringence is affected by the electric field, the first plate or plates or the first prism or prisms comprising a Pockels cell are preferably oriented such that the incident luminous flux is linearly polarized along the axis of the material most sensitive to the electric field. A single Pockels cell is then sufficient.

The second plate or plates or the second prism or prisms, and the third plate or plates or the third prism or prisms, comprising a Pockels cell, are preferably arranged such that their axes along which the polarization is most sensitive to the electric field are perpendicular to one another, such that the luminous flux incident on the second plate or plates or the second prism or prisms exits the third plate or plates or the third prism or prisms deflected in the same way, regardless of the polarization direction of the electric field of the light incident on the second plate or plates or the second prism or prisms.

Pockels cells usually require large potential differences to work, and also a thickness of the order of a centimeter. Preferably, an AC voltage of 4 V between the two electrodes is used per mm of thickness of the Pockels cell, at frequencies for example between 3.765 MHz and 3.775 MHz for a Pockels cell comprising lithium niobate, as described in the article “longitudinal Piezoelectric resonant photoelastic modulator for efficient intensity modulation at megahertz frequencies” published in the journal Nature communications on Mar. 22, 2022. The variation in refractive index then depends on said frequency and said potential difference.

### Polarization Ellipticity Modifier

The polarization ellipticity modifier makes it possible to phase-shift the electric field component of the luminous flux by a predetermined angle along one of two fixed axes.

Preferably, the polarization ellipticity modifier comprises a first birefringent plate or prism designed to split the beam into two electromagnetic waves with linear polarization, one along a first axis, the other along a second axis, and preferably a variable-refractive-index retardation plate arranged on the second axis.

The retardation plate allows the electromagnetic wave oriented along the second axis to acquire a predetermined phase shift with respect to the electromagnetic wave oriented along the first axis, before again being mixed therewith by a new birefringent plate or prism that makes it possible to combine the two electromagnetic waves whose polarization fields are perpendicular along one and the same axis.

The retardation plate may comprise a Pockels cell or a non-linear material. The variable refractive index of the cell makes it possible to choose the phase shift imposed on the electromagnetic wave oriented along the second axis.

The polarization ellipticity modifier may be a Pockels cell.

The Pockels cell consists for example of potassium dihydrogenphosphate KDP (KH2PO4), potassium dideuterium phosphate DKDP (KD2PO4), or lithium niobate (LiNbO3). The Pockels cell may, as a variant, consist of other non-centrosymmetric media such as electric field-polarized polymers, or be placed between two electrodes perpendicular to the incident light ray, the incident light beam arriving with rectilinear polarization, and the birefringence of the cell varying according to the potential difference applied between said two electrodes. As explained in the article published in the journal Nature Communication on Mar. 22, 2022 entitled Longitudinal piezoelectric resonant photoelastic modulator for efficient intensity modulation at megahertz frequencies, the birefringence of the cell may be varied by applying an AC voltage of 2 V applied between the two electrodes, at frequencies for example between 3.765 MHz and 3.78 MHz for a Pockels cell 0.5 mm thick made of lithium niobate, the choice of frequency between these limits deciding the birefringence of said Pockels cell.

The phase shift between the photon polarization components along two perpendicular axes, which phase shift is introduced by the polarization ellipticity modifier, may be chosen from among phase shifts spaced by 9° between −90° and +81°.

### Amplifier

The receiver may comprise, upstream of the measuring instrument, an optical amplifier for multiplying the photon while preserving its polarization state.

Preferably, the optical amplifier is a doped-fiber amplifier.

The optical amplifier is for example an erbium-doped fiber amplifier (EDFA), for example 4 m long, into which the photon to be amplified is introduced at the same time as an amplifying wave of shorter wavelength, thereby making it possible to amplify the wave corresponding to the introduced photon, with gains that may be of the order of 37 db/m.

As a variant, the optical amplifier is a doped fiber amplifier (DFA) using a dopant other than erbium.

As a variant, the optical amplifier may be a vertical-cavity amplifier (VCSOA) or a semiconductor amplifier (SOA).

### Measuring Instrument

Measuring the mean polarization of the photons makes it possible to detect the polarization state of the photons and to deduce therefrom the transmitted information.

The measuring instrument of the receiver may comprise at least one photon detector designed to measure the intensity of the luminous flux along two perpendicular axes and the phase shift of the light between these two same axes.

Preferably, the measuring instrument of the receiver comprises a succession of semi-reflective plates, in particular arranged downstream of the optical amplifier, said plates preferably directing the luminous flux, in predefined proportions, to instruments that make it possible in particular to characterize the ellipticity of the polarization thereof.

Said instruments for characterizing the ellipticity of the polarization are in particular configured to:
measure the intensity of the electric field component of the light along a first axis x,
measure the intensity of the electric field component of the light along a second axis y perpendicular to the first axis x,
measure the phase shift between the light along the axis x and the light along the axis y,
and, preferably, measure the phase shift between the light in the two perpendicular directions x′ and y′, x′ being the bisector of x and y.

The intensity of the photon flux along the two perpendicular axes is measured for example by separating the photon flux along the two perpendicular axes using a birefringent plate or prism, followed by two light intensity sensors placed at the output of said plate or said prism, respectively on each of the two axes.

The polarization ellipticity, that is to say the phase shift of the light between its components along the two perpendicular axes, is measured for example by separating the light along the two perpendicular axes using a birefringent plate or prism. This separation may be followed, for the light polarized along one of the two axes, by a rotation of this polarization axis by 90°, for example by virtue of a rotary or chiral material or using the succession of two quarter-wave plates in order to generate two luminous fluxes with linear polarizations of the same direction, and then a joint projection of these two luminous fluxes through Young's slits, onto a screen, the interference of the two luminous fluxes defining fringes whose positions depend on said phase shift.

As an alternative, the two luminous fluxes may interact with one another by virtue of another interferometer, for example an interferometer mixing the two luminous fluxes into a single flux, using a semi-reflective plate passed through at an angle by one of the two fluxes and reflected at an angle for the other of the two fluxes, the single flux being projected onto a screen, or a camera, in order to measure its intensity, in the same way as a Michelson interferometer.

### Receiver

The receiver preferably comprises a clock, the clocks of the emitter and of the receiver preferably being synchronized with one another.

Between the amplifier and the measuring instruments, the receiver may comprise a succession of multiple lenses and/or mirrors for enlarging the cross section of the light beam.

### Selector

One or more selectors may be configured to send the luminous fluxes to at least one polarization direction modifier.

One or more selectors may make it possible, at the output of the polarization direction modification device or devices, to combine the luminous fluxes along one and the same axis, for example in a guide.

One or more selectors may comprise a mirror whose axis direction is controlled for example by an electrical device. As a variant, one or more selectors may comprise a prism or a plate, made of a material whose refractive index depends on an electric field, for example liquid crystals or a Pockels cell, or made of a transparent material with a non-linear refractive index. An additional luminous flux, for example transverse and preferably having a wavelength different from that of the luminous flux transmitting information, may vary the refractive index of said non-linear material and may thus control the location and possibly the exit direction of the luminous flux from said material.

One or more selectors may be integrated into single components. For example, a selector may have a single input for the light and multiple possible outputs for said light, the output taken by the light depending on the voltage used to actuate said selector.

### Photon Transmission

The photons may or may not be transmitted from the emitter to the receiver in free-field conditions, through space, the atmosphere, via an optical fiber or a combination of these means.

Lenses may be used to transmit the luminous flux, in particular to transmit through space or the atmosphere. Where applicable, anti-reflection layers are preferably arranged on said lenses. The size of the lenses used is preferably adapted to the length of the spatial or atmospheric transmission of the luminous fluxes.

To adjust the direction of emission of a signal-carrying luminous flux, in particular for spatial or atmospheric transmission, it is possible to use a phase-conjugate mirror that reflects the light emitted at the emitter. For example, a laser light emitter may scan a space in order to detect the receiver therein, the receiver reflecting thereto the emitted light by virtue of the phase-conjugate mirror and the direction of the signal-carrying luminous flux then being adjusted so as to be parallel or coincident with the direction of the light reflected by the conjugate mirrors.

The laser light emitted by the laser light emitter may have a wavelength close to the wavelength of the luminous flux emitted by the emitter, transmitting information, and introduced into an objective used by the luminous flux transmitting information using a dichroic prism.

In one variant, a luminous flux used for alignment may be emitted in parallel with the luminous flux transmitting information but at a distance of for example a few centimeters so as to be reflected by a phase-conjugate mirror.

In another variant, it is possible not to use a phase-conjugate mirror and to target the receiver or a target close thereto, the information according to which the target is received being communicated by another communication means, in particular by radio signal, or optically, the conjugate mirror then being designed to dynamically modulate the reflection.

The area to be scanned may be identified by map recognition of the area in which said receiver is likely to be located.

### Anti-Reflection Coating

Anti-reflection layers may be arranged at the interfaces between adjacent transparent media of different indices passed through by the luminous fluxes and/or at the interfaces of the birefringent prisms and/or plates passed through by the luminous fluxes. The anti-reflection layers make it possible to avoid luminous flux loss.

The anti-reflection layers are preferably adapted to the index or indices of the materials, and/or to the angle or angles of incidence and polarization directions of the luminous flux that have to pass through it, and/or to the wavelength of the luminous flux.

### Dichroic Filters

The receiver preferably comprises one or more dichroic filters allowing only luminous fluxes of a given wavelength to pass through, in particular a prism made of a dispersive transparent material.

The filter or filters are preferably arranged in front of the measuring instrument or instruments, in particular if the refractive indices of the non-linear materials are modified by applying strong luminous fluxes.

### Photonic Communication Method

According to another of its aspects, the invention relates to a photonic communication method transmitting information coded on a luminous flux, using the system described above, comprising the following steps:
(1) Generating a polarized luminous flux with a predetermined polarization from an emitter, the luminous flux being emitted to a receiver,
(2) Coding the information on the luminous flux by introducing, using a polarization modifier arranged between the emitter and the receiver, a modification of the polarization direction of the luminous flux and a phase shift between the polarization components of the luminous flux along the two eigenaxes of the polarization modifier, the modification of the direction and the phase shift depending on the information to be transmitted,
(3) Measuring the average phase shift between the polarization components of the luminous flux along two perpendicular axes and the proportion of the luminous intensity along these same axes, and determining the information transmitted by the emitter according to these measurements.

Preferably, the photonic communication method comprises, between step (2) and step (3), in particular if the luminous flux is composed of only one or a few photons: duplicating the photon into a photon flux at the receiver, using an amplification device, the light thus created having preserved the polarization state of the photon received at the receiver,

The same information may be coded on a predetermined number N of photons emitted successively by the emitter.

The phase shift between the polarization components of the luminous flux along two perpendicular axes may be chosen from among phase shifts spaced by 9° between −90° and +81°, and/or the polarization direction of the luminous flux may be chosen from among directions spaced by 9° between −90° and +81°, the polarization state of the luminous flux then being chosen from among 361 distinct polarization states.

The receiver may consider to have received the information after having measured, in step (4), a predetermined number n of photons carrying the same information, received by the receiver.

The emitter may transmit a coded message comprising a plurality of items of information, in particular a plurality of letters, preferably each coded on one or more photons.

A transmitted item of information, in particular a transmitted letter, coded on one or more photons may be separated from another transmitted item of information, in particular from another transmitted letter, by transmitting separation information, in particular a separation letter, coded on one or more photons. Preferably, the transmission of two identical items of information, in particular two identical letters, is separated by the transmission of separation information, in particular a separation letter.

### Device for Modifying Polarization Direction

According to another of its aspects, the invention relates to a device for modifying the polarization direction of a luminous flux, the device belonging for example to an optical communication system, in particular to the optical communication system described above, the device comprising:
one or more first plates or one or more first prisms whose refractive index or indices are dynamically adjustable,
downstream of the first plate or plates or of the first prism or prisms, an intermediate device designed to rotate the polarization direction of the luminous flux by an angle that depends on the point via which the luminous flux enters said intermediate device, and
downstream of the intermediate device, one or more second plates or one or more second prisms, and possibly one or more third plates or one or more third prisms, the refractive index or indices of which are dynamically adjustable.

The device for modifying polarization direction makes it possible to rotate the polarization direction of a linearly polarized luminous flux under the effect of an electric command generating electric fields.

The intermediate device may comprise a plate or a prism.

The intermediate device may comprise an at least partially chiral or rotary material.

The refractive index or indices of the second plate or plates or of the second prism or prisms, and possibly of the third plate or plates or of the third prism or prisms, are in particular adjusted symmetrically with respect to those of the first plate or plates or of the first prism or prisms.

### Device for Modifying Polarization Direction

According to another of its aspects, the invention relates to a device for modifying the polarization direction of a luminous flux, the device belonging for example to an optical communication system, in particular to the optical communication system described above, the device comprising multiple stacked layers:
a first layer being a lithium niobate crystal subjected to a first electric field E_{C1} of intensity U in a direction y inducing a variation Δnₓ in its refractive index for luminous fluxes polarized in a direction x perpendicular to the direction y, and a variation Δn_{y} in its refractive index for luminous fluxes polarized in the direction y,
a second layer being a second lithium niobate crystal oriented at 90° about the axis x with respect to the first layer, subjected to a second electric field E_{C2} of the same intensity U as the first perpendicular to the plane xy, the field E_{C2} inducing the variation Δnₓ in its refractive index for luminous fluxes polarized in the direction y and the variation Δn_{y} in its refractive index for luminous fluxes polarized in the direction x,
a third layer being a quarter-wave plate for the luminous flux coming from the second layer that enters the third layer at an entry point, the position of the entry point on the third layer depending on the intensity of the electric fields E_{C1} and E_{C2},
a fourth layer being a succession of quarter-wave plates oriented such that the light coming from the third layer enters it circularly polarized and exits it linearly polarized in a direction depending on its entry point into the fourth layer,
a fifth and a sixth layer of the same nature and orientation as the first and second layers, respectively, and subjected to electric fields in the direction y and in the direction perpendicular to the plane xy, respectively, whose equal intensities U′ are adjusted as a function of the electric fields E_{C1} and E_{C2}, so that the light ray exiting the sixth layer exits at an invariant point regardless of the value of the intensity U of the electric fields E_{C1} and E_{C2}.

The first, second, fifth and sixth layers (81; 82; 85; 86) may be liquid crystals or Pockels cells arranged between two transparent electrodes, or the refractive indices of the first, second, fifth and sixth layers (81; 82; 85; 86) may be modulated by applying an intense light, and the first, second, fifth and sixth layers (81; 82; 85; 86) may be composed of materials with a non-linear refractive index.

### Device for Receiving a Luminous Flux

According to another of its aspects, the invention relates to a device for receiving a luminous flux, designed to measure the ellipticity and the orientation of the polarization of a light using the Jones formalism, the device belonging for example to an optical communication system, in particular to the optical communication system described above, the device comprising:
an amplifier, for example a doped fiber-optic amplifier, configured to amplify the light, thus creating a luminous flux,
an optical device comprising: two semi-reflective mirrors, a mirror, three prisms, two photosensitive sensors, two cameras and three polarization direction modifiers,
   the first semi-reflective mirror being configured to reflect and deflect a portion of the luminous flux, for example one third, at the output of the amplifier, to a first birefringent prism separating the polarized deflected light into two luminous fluxes along the two eigenaxes of the prism, the two luminous fluxes being sent respectively to photosensitive sensors, which measure their respective intensity,
   the second semi-reflective mirror being configured to reflect a portion of the luminous flux, for example half, not reflected at the output of the first mirror, and deflect this reflected flux in the direction of a second birefringent prism separating the polarized deflected light into two luminous fluxes along the two eigenaxes of the second prism, the first luminous flux then being sent to a first camera for illumination on a surface Si, the second flux being sent to a first polarization direction modifier, which modifies the polarization direction of the second flux by 90° before sending this flux to the same surface Si of the first camera, interference fringes then appearing on the camera, the position of which makes it possible to measure the phase shift between the fluxes oriented along the two eigenaxes of the second prism,
   the second polarization direction modifier being configured such that the luminous flux not reflected by the second semi-reflective mirror passes through the second polarization direction modifier, which modifies the polarization direction of the flux by 45°, the third mirror being configured to reflect the luminous flux that has passed through the second polarization direction modifier, and deflect this reflected flux in the direction of a third birefringent prism separating the polarized deflected light into two luminous fluxes along the two eigenaxes of the third prism, the first luminous flux being sent to a surface Si′ of a second camera, the second flux being sent to a third polarization direction modifier, which rotates the polarization direction of the second flux by 90° before sending this flux to the same surface Si′ of the third camera, interference fringes then appearing on the camera, thereby expressing the phase shift between the fluxes oriented along the two eigenaxes of the third prism.

### BRIEF DESCRIPTION OF THE DRAWINGS

The invention will be able to be better understood upon reading the following detailed description of non-limiting exemplary implementations thereof, and upon examining the appended drawing, in which:

FIG. 1 schematically and partially shows a communication system according to the invention,

FIG. 2A schematically and partially shows a linearly polarized photon,

FIG. 2B schematically and partially shows two circularly polarized photons,

FIG. 3 schematically and partially shows a polarization direction modifier according to the invention,

FIG. 4 schematically and partially shows a device rotating the polarization axis of a linearly polarized light under the effect of an electric command,

FIG. 5 schematically and partially shows a polarization ellipticity modifier according to the invention, and

FIG. 6 schematically and partially shows a receiver according to the invention.

### DETAILED DESCRIPTION

FIG. 1 shows an optical communication system S according to the invention comprising a luminous flux emitter, a polarization modifier 2 and a receiver 3.

The luminous flux emitter comprises a source 1 configured to emit non-polarized light, in the direction of a polarizing filter 4 that polarizes the light linearly, for example vertically. As a variant, the source 1 may emit a linearly polarized light in the direction of the polarization modifier 2, without there being a polarization filter 4 in the system S.

Downstream of the polarization filter 4, on the path of the light, the polarization modifier 2 introduces a modification of the polarization direction and a phase shift between the polarization components of the light along two eigenaxes of the polarization modifier 2, the angle of rotation of the polarization direction and the value of the introduced phase shift corresponding for example to a letter A.

At the output of the polarization modifier 2, the light is sent into an optical fiber 5, in the direction of the receiver 3.

The receiver 3 comprises an optical amplifier 31 and one or more measuring instruments 35 for measuring the intensity of the electric field corresponding to the luminous flux along two perpendicular axes and also the phase shift between the components of said electric field along these axes, and deducing therefrom the transmitted information, for example the letter A. The receiver 3 may furthermore comprise an optical device 36 for directing the amplified luminous flux in the direction of the measuring instrument or instruments.

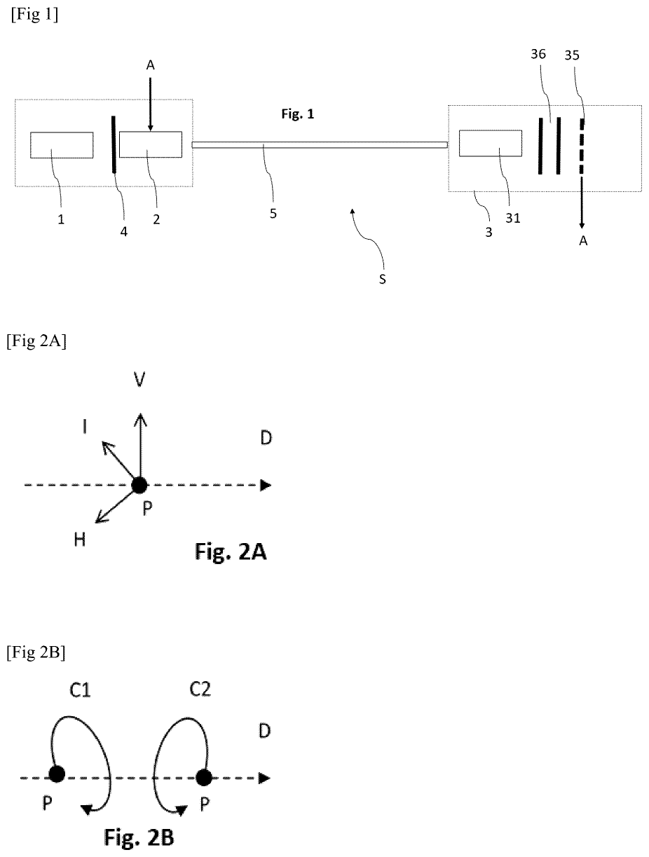

FIG. 2A illustrates the linear polarization/of a photon P moving in a direction D. The linear polarization/is broken down in this example onto two axes, one vertical V and the other horizontal H.

FIG. 2B illustrates the circular polarization of a photon P moving in a direction D. The circular polarization of the photon P rotates about the axis D; it may rotate clockwise, like the polarization C1, or anticlockwise, like the polarization C2.

### Polarization Direction Modifier

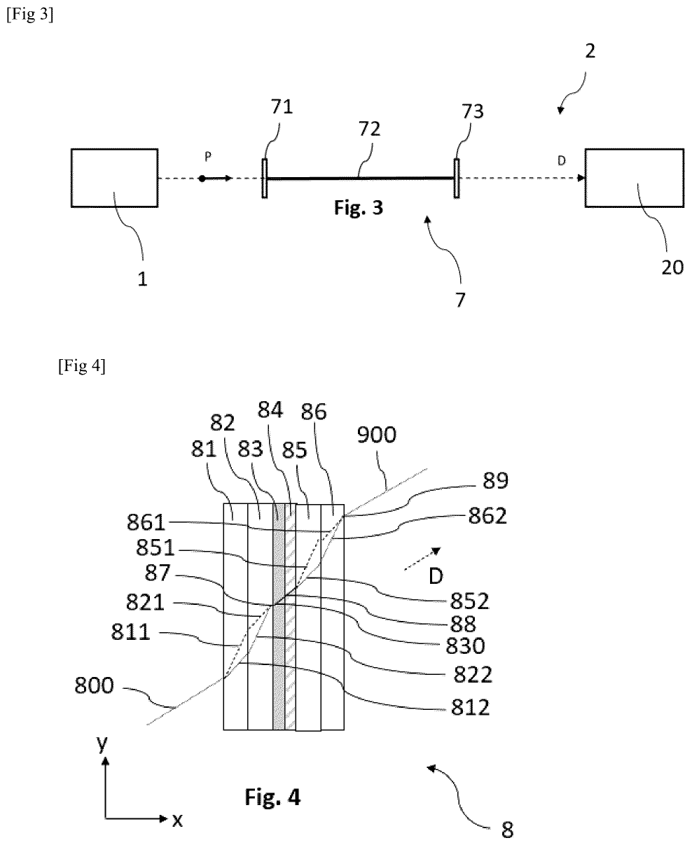

The polarization modifier 2 may comprise a polarization direction modifier 7 or 8, as illustrated in FIGS. 3 and 4, on the path of the linearly polarized photon P, between the emitter and a polarization ellipticity modifier 20.

In a first embodiment illustrated in FIG. 3, the polarization direction modifier 7 comprises a first quarter-wave plate 71 for transforming the linear polarization of the photon P into a circular polarization. Downstream of the plate 71, the polarization direction modifier 7 comprises a transparent medium 72, followed by a second quarter-wave plate 73 for transforming the circular polarization of the photon P into a linear polarization in a determined direction.

The quarter-wave plate 73 is rotated for example by mechanical servo-control to a sensor or to an electrically controlled device allowing the rotation thereof, for example by rubbing on an axle set in motion by a piezoelectric material or by an electric motor device, for example a DC electric motor device.

In a second embodiment illustrated in FIG. 4, the polarization direction modifier 8 rotates the polarization direction of a linearly polarized photon under the effect of an electric command generating electric fields.

The polarization direction modifier 8 comprises multiple stacked layers.

The first layer 81 is for example a lithium niobate crystal subjected to a first electric field E_{C1} in the direction y, inducing a variation Δnₓ in its refractive index for waves polarized in the direction x and a variation Δn_{y} in its refractive index for waves polarized in the direction y.

When the incident light 800 enters this first layer 81, it is separated into two rays 811 and 812.

The second layer 82 is for example a second lithium niobate crystal oriented at 90° about the axis x with respect to the first layer, subjected to a second electric field E_{C2} of the same intensity U as the first, perpendicular to the plane of FIG. 4. The field E_{C2} induces the variation Δnₓ in its refractive index for waves polarized in the direction y and the variation Δn_{y} in its refractive index for waves polarized in the direction x. When the rays 811 and 812 enter this second layer 82, they change direction again so as to become the rays 821 and 822.

The two rays 821 and 822 are combined into a single ray 830 at the exit of the layer 82, when it enters the layer 83 at the point 87. The position of the point 87 on the layer 83 depends on the intensity of the electric fields E_{C1} and E_{C2}. The direction of the ray 830 is independent of the intensity U of the electric fields E_{C1} and E_{C2}, which remain equal.

The layer 83 is for example a quarter-wave plate for the rays entering it with the direction of the ray 830 coming from the second layer 82. The light ray 830 enters, at the exit of the layer 83 at an entry point 88, onto a succession of quarter-wave plates 84 oriented such that the light enters same circularly polarized in the direction of the ray 830 and exits therefrom linearly polarized in a direction that depends on its entry point 88.

The light ray exiting the layer 84 passes through the layers 85 and 86 and exits the layer 86 at the point 89 so as to form the ray 900. The layers 85 and 86 are of the same nature and orientation as the first and second layers 81 and 82, respectively, and are subjected to electric fields in the direction y and in the direction perpendicular to the plane of FIG. 4, respectively, whose equal intensities U′ are adjusted as a function of the electric fields E_{C1} and E_{C2}, so that the light ray 900 exits at an invariant point 89 regardless of the value of the intensity U of the electric fields E_{C1} and E_{C2}.

The layers 81, 82, 85 and 86 are for example liquid crystals or Pockels cells arranged between two transparent electrodes. As an alternative, the refractive indices of the layers 81, 82, 85 and 86 are modulated by applying an intense light and the layers 81, 82, 85 and 86 are composed of materials with a non-linear refractive index.

### Polarization Ellipticity Modifier

The polarization modifier 2 may comprise a polarization ellipticity modifier 20.

The polarization ellipticity modifier 20 makes it possible to introduce a phase shift between the two polarization components along two perpendicular axes of a photon.

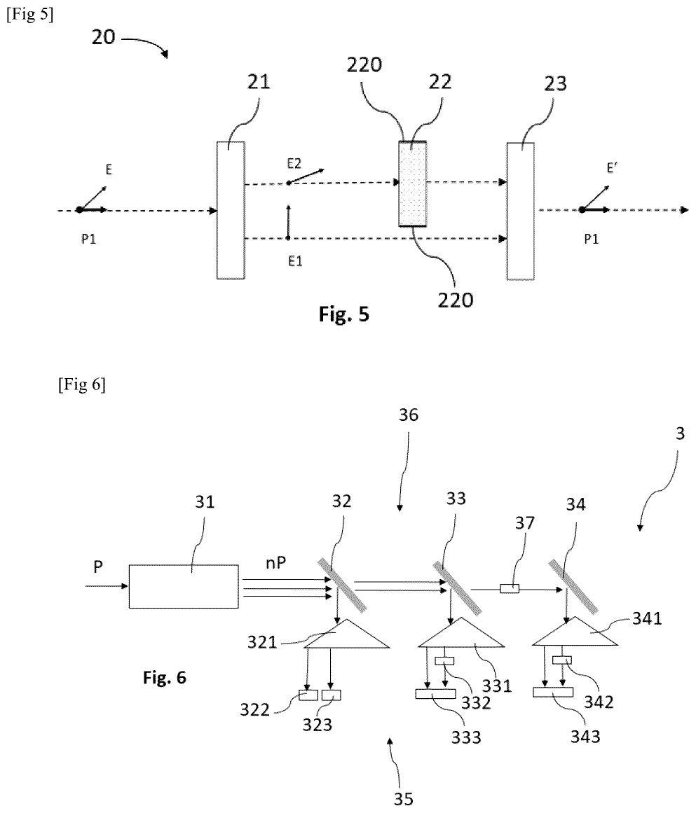

The polarization ellipticity modifier 20 illustrated in FIG. 5 comprises a first birefringent crystal plate 21 splitting the light beam P1 into two electromagnetic waves, with linear polarization E1 and E2, one along a first axis, the other along a second axis perpendicular to the first.

The polarization ellipticity modifier 20 comprises, downstream of this plate 21, a Pockels cell 22, for example made of lithium niobate, arranged on the second axis. The Pockels cell 22 is passed through by an adjustable electric field generated by electrodes 220, for example perpendicular to the direction of propagation of the light. The Pockels cell makes it possible for the wave oriented along the second axis, with polarization E2, to acquire a predetermined phase shift with respect to the wave oriented along the first axis, with polarization E1.

Finally, the polarization ellipticity modifier 20 comprises, downstream of the Pockels cell 22, a second birefringent crystal plate 23 that combines the two waves E1 and E2 along one and the same axis, thereby creating a single beam P1.

### Receiver

FIG. 6 illustrates a receiver 3 comprising an amplifier 31 for amplifying a light P, thus creating a luminous flux nP. The amplifier 31 is for example a doped fiber-optic amplifier.

The receiver 3 moreover comprises an optical device comprising two semi-reflective mirrors 32 and 33 and a mirror 34. The first semi-reflective mirror 32 reflects and deflects a portion of the luminous flux nP, for example one third, at the output of the amplifier 31, to a first birefringent prism 321. The birefringent prism 321 separates the polarized deflected light into two luminous fluxes along the two eigenaxes of the prism 321. The two luminous fluxes are then sent respectively to photosensitive sensors 322 and 323, which measure their respective intensity.

A second semi-reflective mirror 33 reflects a portion of the luminous flux, for example half, not reflected at the output of the first mirror 32, and deflects this reflected flux in the direction of a second birefringent prism 331. The birefringent prism 331 separates the polarized deflected light into two luminous fluxes along the two eigenaxes of the prism 331. The first luminous flux is then sent to a camera 333 for illumination on a surface Si, the second flux is sent to a polarization direction modifier 332, which modifies the polarization direction of the second flux by 90° before sending this flux to the same surface Si of the camera 333. Interference fringes then appear on the camera, the position of which makes it possible to measure the phase shift between the fluxes oriented along the two eigenaxes of the prism 331.

The luminous flux not reflected by the second semi-reflective mirror 33 then passes through a polarization direction modifier 37, which modifies the polarization direction of the flux by 45°.

A third reflective mirror 34 then reflects the luminous flux that has passed through the polarization direction modifier 37, and deflects this reflected flux in the direction of a third birefringent prism 341. The birefringent prism 341 separates the polarized deflected light into two luminous fluxes along the two eigenaxes of the prism 341. The first luminous flux is then sent to a surface Si′ of a camera 343, the second flux is sent to a polarization direction modifier 342, which rotates the polarization direction of the second flux by 90° before sending this flux to the same surface Si′ of the camera 343. Interference fringes then appear on the camera, thereby expressing the phase shift between the fluxes oriented along the two eigenaxes of the prism 341.

1. An optical communication system comprising:
A polarized-light emitter comprising a source configured to generate at least one photon polarized with a predetermined polarization on a propagation path;
A complex polarization modifier placed on the propagation path of the light generated by the emitter, configured to modify the polarization direction of said light and introduce a phase shift between two perpendicular components of the electric field of the light; and
A receiver arranged on the propagation path of the light, downstream of the complex polarization modifier, comprising a measuring instrument for measuring the ellipticity and the orientation of the polarization of the light using the Jones formalism.

2. The system as claimed in claim 1, wherein the emitter being configured to emit the light with a predetermined polarization, in particular with a linear polarization.

3. The system as claimed in claim 2, wherein the emitter comprising, downstream of the source, a linear polarizer configured to select a polarization direction of the photon.

4. The system as claimed in claim 1, wherein the polarization modifier comprising a polarization ellipticity modifier arranged on the propagation path between the emitter and the receiver.

5. The system as claimed in claim 4, wherein the polarization modifier comprising a polarization direction modifier arranged on the propagation path between the emitter and the polarization ellipticity modifier or between the polarization ellipticity modifier and the receiver.

6. The system as claimed in claim 5, wherein the polarization direction modifier comprising a first quarter-wave plate configured to modify the linear polarization of the luminous flux incident on the polarization direction modifier to circular polarization, followed by a second quarter-wave plate transforming the circular polarization into linear polarization of the luminous flux oriented along an axis depending on the direction of the axis of the second quarter-wave plate.

7. The system as claimed in claim 5, wherein the polarization direction modifier comprising:
one or more first plates or one or more first prisms whose refractive index or indices are dynamically adjustable,
downstream of the first plate or plates or of the first prism or prisms, an intermediate device, in particular comprising an at least partially chiral or rotary material, and
downstream of the intermediate device, one or more second plates or one or more second prisms, and possibly one or more third plates or one or more third prisms, whose refractive index or indices are dynamically adjustable and for which the refractive index or indices are in particular adjusted symmetrically with respect to those of the first plate or plates or of the first prism or prisms.

8. The system as claimed in claim 1,
wherein the polarization modifier comprising a polarization ellipticity modifier arranged on the propagation path between the emitter and the receiver, and
wherein the polarization ellipticity modifier comprising a first birefringent plate or prism splitting the beam into two electromagnetic waves with linear polarization, one along a first axis, the other along a second axis, and a variable-refractive-index retardation plate arranged on the second axis.

9. The system as claimed in claim 1, wherein the measuring instrument of the receiver comprising at least one photon detector, designed to measure the intensity of the luminous flux along two perpendicular axes and the phase shift of the light between these two same axes.

10. The system as claimed in claim 1, wherein the receiver comprising an optical amplifier upstream of the measuring instrument of the receiver and the measuring instrument of the receiver comprising a succession of semi-reflective plates arranged downstream of the optical amplifier, said plates directing the luminous flux, in predefined proportions, to instruments that make it possible to characterize the ellipticity of the polarization thereof.

11. The system as claimed in claim 1, wherein the receiver comprising an optical amplifier upstream of the measuring instrument of the receiver and the optical amplifier being a doped fiber amplifier.

12. The system as claimed in claim 1, wherein the emitter being configured to successively generate a plurality of photons.

13. A photonic communication method transmitting coded information on a luminous flux, using the system of claim 1, the method comprising the following steps:
(1) Generating a polarized luminous flux with a predetermined polarization from an emitter, the luminous flux being emitted to a receiver,
(2) Coding the information on the luminous flux by introducing, using a polarization modifier arranged between the emitter and the receiver, a modification of the polarization direction of the luminous flux and a phase shift between the polarization components of the luminous flux along the two eigenaxes of the polarization modifier, the modification of the direction and the phase shift depending on the information to be transmitted, and
(3) Measuring the average phase shift between the polarization components of the luminous flux along two perpendicular axes and the proportion of the luminous intensity along these same axes, and determining the information transmitted by the emitter according to these measurements.

14. The method as claimed in claim 13, further comprising, between step and step, in particular if the luminous flux is composed of only one or a few photons: duplicating the photon into a photon flux at the receiver, using an amplification device, the light thus created having preserved the polarization state of the photon received at the receiver.

15. The method as claimed in claim 13, the phase shift between the polarization components of the luminous flux along two perpendicular axes being chosen from among phase shifts spaced by 9° between −90° and +81°, and/or the polarization direction of the luminous flux being chosen from among directions spaced by 9° between −90° and +81°, the polarization state of the luminous flux then being chosen from among 361 distinct polarization states.

16. The method as claimed in claim 13, wherein the same information being coded on a predetermined number N of photons emitted successively by the emitter.

17. The method as claimed in claim 16, wherein the receiver considering to have received the information after having measured, in step, a predetermined number n of photons received by the receiver carrying the same information.

18. The method as claimed in claim 13, wherein the emitter transmitting a coded message comprising a plurality of items of information (A), in particular a plurality of letters (A), each coded on one or more photons.

19. The method as claimed in claim 18, wherein a transmitted item of information (A), in particular a transmitted letter (A), coded on one or more photons, being separated from another transmitted item of information, in particular from another transmitted letter, by transmitting separation information, in particular a separation letter, coded on one or more photons,
preferably, the transmission of two identical items of information, in particular two identical letters, being separated by the transmission of separation information, in particular a separation letter.

20. A device for modifying the polarization direction of a luminous flux belonging to the optical communication system described in claim 1, the device comprising:
one or more first plates or one or more first prisms whose refractive index or indices are dynamically adjustable,
downstream of the first plate or plates or of the first prism or prisms, an intermediate device designed to rotate the polarization direction of the luminous flux by an angle that depends on the point via which the luminous flux enters said intermediate device, and
downstream of the intermediate device, one or more second plates or one or more second prisms, and possibly one or more third plates or one or more third prisms, the refractive index or indices of which are dynamically adjustable.

21. The device as claimed in claim 20, wherein the intermediate device comprising an at least partially chiral or rotary material.

22. The device as claimed in claim 20, wherein the refractive index or indices of the second plate or plates or of the second prism or prisms being adjusted symmetrically with respect to those of the first plate or plates or of the first prism or prisms.

23. A device for modifying the polarization direction of a luminous flux belonging to the optical communication system described in claim 1, the device comprising multiple stacked layers:
a first layer being a lithium niobate crystal subjected to a first electric field E_{C1} of intensity U in a direction y inducing a variation Δnₓ in its refractive index for luminous fluxes polarized in a direction x perpendicular to the direction y, and a variation Δn_{y} in its refractive index for luminous fluxes polarized in the direction y,
a second layer being a second lithium niobate crystal oriented at 90° about the axis x with respect to the first layer, subjected to a second electric field E_{C2} of the same intensity U as the first perpendicular to the plane xy, the field E_{C2} inducing the variation Δnₓ in its refractive index for luminous fluxes polarized in the direction y and the variation Δn_{y} in its refractive index for luminous fluxes polarized in the direction x,
a third layer being a quarter-wave plate for the luminous flux coming from the second layer that enters the third layer at an entry point, the position of the entry point on the third layer depending on the intensity of the electric fields E_{C1} and E_{C2},
a fourth layer being a succession of quarter-wave plates oriented such that the light coming from the third layer enters it circularly polarized and exits it linearly polarized in a direction depending on its entry point into the fourth layer, and
a fifth and a sixth layer of the same nature and orientation as the first and second layers, respectively, and subjected to electric fields in the direction y and in the direction perpendicular to the plane xy, respectively, whose equal intensities U′ are adjusted as a function of the electric fields E_{C1} and E_{C2}, so that the light ray exiting the sixth layer exits at an invariant point regardless of the value of the intensity U of the electric fields E_{C1} and E_{C2}.

24. The device as claimed in claim 23, wherein the first, second, fifth and sixth layers being liquid crystals or Pockels cells arranged between two transparent electrodes, or the refractive indices of the first, second, fifth and sixth layers being modulated by applying an intense light, and the first, second, fifth and sixth layers being composed of materials with a non-linear refractive index.

25. A device for receiving a luminous flux, designed to measure the ellipticity and the orientation of the polarization of a light using the Jones formalism, the device belonging to the optical communication system described in claim 1, the device comprising:
an amplifier, for example a doped fiber-optic amplifier, configured to amplify the light, thus creating a luminous flux,
an optical device comprising: two semi-reflective mirrors, a mirror, three prisms, two photosensitive sensors, two cameras and three polarization direction modifiers,
the first semi-reflective mirror being configured to reflect and deflect a portion of the luminous flux, for example one third, at the output of the amplifier, to a first birefringent prism separating the polarized deflected light into two luminous fluxes along the two eigenaxes of the prism, the two luminous fluxes being sent respectively to photosensitive sensors, which measure their respective intensity,
the second semi-reflective mirror being configured to reflect a portion of the luminous flux, for example half, not reflected at the output of the first mirror, and deflect this reflected flux in the direction of a second birefringent prism separating the polarized deflected light into two luminous fluxes along the two eigenaxes of the second prism, the first luminous flux then being sent to a first camera for illumination on a surface Si, the second flux being sent to a first polarization direction modifier, which modifies the polarization direction of the second flux by 90° before sending this flux to the same surface Si of the first camera, interference fringes then appearing on the camera, the position of which makes it possible to measure the phase shift between the fluxes oriented along the two eigenaxes of the second prism,
the second polarization direction modifier being configured such that the luminous flux not reflected by the second semi-reflective mirror passes through the second polarization direction modifier, which modifies the polarization direction of the flux by 45°, the third mirror being configured to reflect the luminous flux that has passed through the second polarization direction modifier, and deflect this reflected flux in the direction of a third birefringent prism separating the polarized deflected light into two luminous fluxes along the two eigenaxes of the third prism, the first luminous flux being sent to a surface Si′ of a second camera, the second flux being sent to a third polarization direction modifier, which rotates the polarization direction of the second flux by 90° before sending this flux to the same surface Si′ of the third camera, interference fringes then appearing on the camera, thereby expressing the phase shift between the fluxes oriented along the two eigenaxes of the third prism.
